(19) United States
(12) Patent Application Publication
(10) Pub. No.: US 2005/0069727 A1
(43) Pub. Date: Mar. 31, 2005

(54) Oled emissive polymer layer

(76) Inventors: Rahul Gupta, Santa Clara, CA (US); Florian Pschenitzka, San Jose, CA (US); Franky So, San Jose, CA (US); Pierre-Marc Allemand, San Jose, CA (US); Vi-En Choong, San Jose, CA (US)

Correspondence Address: Siemens Corporation;Attn: Elsa Keller, Legal Administrator, Intellectual Property Department, 170 Wood Avenue South, Iselin, NJ, 08830, US

(21) Appl. No.: 10/676,697

(22) Filed: Sep. 30, 2003

(51) Int. Cl. H05B 33/14; C09K 11/06

(52) U.S. Cl. 428/690; 428/917; 313/504; 313/506; 257/88; 257/40; 252/301.35

(57) ABSTRACT

The position of the recombination zone can be controlled by controlling the mobility of the charge carriers. In an embodiment of the invention, the mobility of the charge carriers within the emissive polymer layer is controlled by the addition of traps—either electron traps, hole traps, or electron/hole traps. The electron traps reduce electron mobility, the hole traps reduce hole mobility, and the electron/hole traps reduce both electron mobility and hole mobility. The electron mobility and/or the hole mobility can be altered using the traps so that the recombination zone is positioned in the emissive polymer layer sufficiently far from the cathode so that quenching is minimized, and sufficiently far from the HTL/emissive polymer layer interface so that lifetime and/or efficiency is improved.

### BACKGROUND OF THE INVENTION

An organic light emitting diode (“OLED”) device typically includes, for example: (1) an anode on a substrate; (2) a hole transporting layer (“HTL”) on the anode; (3) an electron transporting and light emitting layer (“emissive polymer layer”) on the HTL; and (4) a cathode on the emissive polymer layer. When the device is forward biased, holes are injected from the anode into the HTL, and the electrons are injected from the cathode into the emissive polymer layer. Both carriers are then transported towards the opposite electrode and allowed to form excitons and to recombine with each other with emission of a photon. The recombination zone is the region where the product of the densities of electrons and holes is maximum.

The position of the recombination zone is determined in part by the relative rates of motion (mobilities) of the two charge carriers (e.g., electrons and holes) within the emissive polymer layer. If the electron mobility is greater than the hole mobility in the emissive polymer layer, then the recombination zone is localized in the region close to the HTL/emissive polymer layer interface. In this case, some electrons may leak into the HTL resulting in degradation of this layer and thus decreasing the lifetime of the device.

If, on the other hand, the hole mobility is greater than the electron mobility in the emissive polymer layer, then the recombination zone is close to the cathode. If the recombination zone is close to the cathode, then the light emission may be quenched thus decreasing efficiency.

To improve efficiency, the OLED device should be designed so that the recombination zone is positioned in the emissive layer sufficiently far from the cathode so that quenching is minimized, and sufficiently far from the HTL/emissive layer interface so that lifetime and/or efficiency is improved.

Therefore, in order to, for example, improve device efficiency and/or lifetime, there is a need to control the recombination zone within the emissive polymer layer.

### SUMMARY

An embodiment of an emissive polymer layer is described. The emissive polymer layer includes host components, and (1) electron traps, (2) hole traps, and/or (3) electron/hole traps. The electron traps reduce electron mobility within the emissive polymer layer, the hole traps reduce hole mobility within the emissive polymer layer, and the electron/hole traps reduce both electron mobility and hole mobility within the emissive polymer layer.

### BRIEF DESCRIPTION OF THE DRAWINGS

FIG. 1 shows energy bands of a first configuration of an emissive polymer layer in which an electron trap is added to a host component of the emissive polymer layer.

FIG. 2 shows energy bands of a second configuration of an emissive polymer layer in which a hole trap is added to a host component of the emissive polymer layer.

FIG. 3 shows energy bands of a third configuration of an emissive polymer layer in which an electron/hole trap is added to a host component of the emissive polymer layer.

FIG. 4 shows an energy band diagram for the first configuration of the emissive polymer layer in which electron traps are added to the host components.

FIG. 5 shows an energy band diagram for the second configuration of the emissive polymer layer in which hole traps are added to the host components.

FIG. 6 shows an energy band diagram for the third configuration of the emissive polymer layer in which electron/hole traps are added to the host components.

FIG. 7 shows a cross-sectional view of an embodiment of an electronic device according to the present invention.

### DETAILED DESCRIPTION

To improve efficiency, the OLED device should be designed so that the recombination zone is positioned in the emissive polymer layer sufficiently far from the cathode so that quenching is minimized, and sufficiently far from the HTL/emissive polymer layer interface so that lifetime and/or efficiency is improved. The position of the recombination zone can be controlled by controlling the mobility of the charge carriers. In an embodiment of the invention, the mobility of the charge carriers within the emissive polymer layer is controlled by the addition of traps—electron traps, hole traps, and/or electron/hole traps. The electron traps reduce electron mobility within the emissive polymer layer, the hole traps reduce hole mobility, and the electron/hole traps reduce both electron mobility and hole mobility. By adding the traps to the emissive polymer layer, the mobility of the faster moving carrier can be reduced so that it is close to the mobility of the slower moving carrier. The mobilities of one or both carriers can be adjusted so that there is an almost equal number of holes and electrons in the recombination zone and the zone is positioned sufficiently far from the cathode so that quenching is minimized, and sufficiently far from the HTL/emissive polymer layer interface so that lifetime and/or efficiency is improved. If the number of each of the two charge carriers in the recombination zone is made similar, then the probability of recombinations is maximized (e.g., the larger the ratio of recombinations to injected carriers, the better is the efficiency of the device) and also fewer charges “escape” the emissive polymer layer.

By reducing the mobility of the faster carrier, we can control the position of the recombination zone. For example, if electrons are the faster carriers, then the recombination zone would be very close to the HTL/emissive polymer layer interface. By reducing the mobility of the electrons, they will recombine with holes in the emissive polymer layer before they can reach the HTL/emissive polymer layer interface. Thus, we can move the recombination zone away from the HTL/emissive polymer layer interface. On the other hand, if the hole mobility is greater than the electron mobility, we can reduce the hole mobility to move the recombination zone farther away from the cathode.

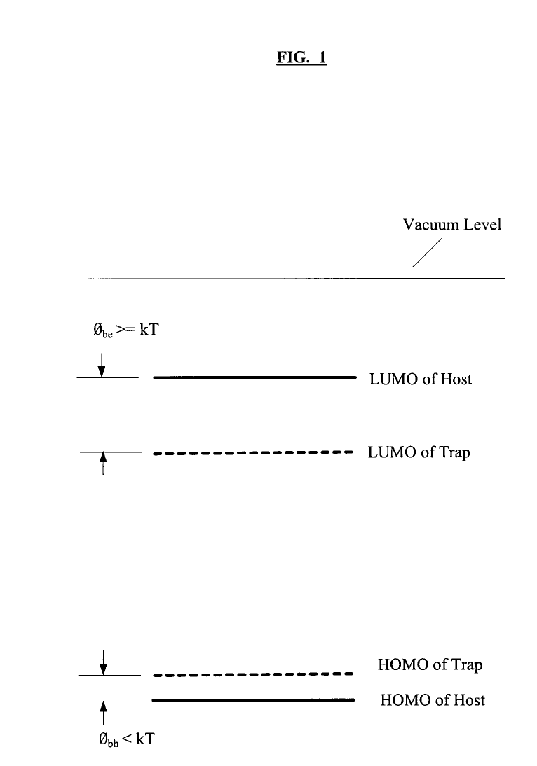

If the electron mobility of the emissive polymer layer is greater than the hole mobility, then traps can be added to the emissive polymer layer to trap electrons in order to reduce the electron mobility so that the electron mobility is closer to the hole mobility. FIG. 1 shows energy bands of a first configuration of an emissive polymer layer 103 in which an electron trap is added to a host component of the emissive polymer layer. The electron trap can be added to the host emissive polymer component by, for example, mixing these two components or by chemically bonding these two components. The two components can be chemically bonded by, for example, incorporating the electron trap within the main chain of the host component, or attaching the electron trap as a side group to the main chain of the host component. The electron trap has a LUMO (“lowest unoccupied molecular orbital”) level that is lower than the LUMO level of the host component. The difference between the LUMO level of the electron trap and the LUMO level of the host component is referred to as the energy barrier to trap electrons (“∅_{be}”). The reduction in electron mobility due to the trap depends in part on the height of this energy barrier. The larger the barrier height, the greater the reduction in electron mobility. The number of empty traps at a temperature T (in Kelvins), is given by the equation: N=N_{T}exp(−∅_{be}/kT) where “N_{T}” is the total number of electron traps and “kT” is the thermal energy (kT=0.0259 eV at T=300K). If “∅_{be}” is less than “kT”, then the trapping effect is not significant enough to reduce the electron mobility. If, however, “∅_{be}” is much greater than “kT”, then electrons are trapped but the trapped electrons have a very low probability of having enough energy to be re-excited. In order to sufficiently trap charges so that electron mobility is reduced, the “∅_{be}” should be at least “kT”.

The band lineups are chosen to be such that electron traps do not significantly reduce the hole mobility of the emissive polymer layer. The difference between the HOMO (“highest occupied molecular orbital”) level of the electron trap and the HOMO level of the host component is referred to as the energy barrier to trap holes (“∅_{bh}”). The reduction in hole mobility due to the trap depends on the height of this energy barrier. The larger the height of the energy barrier, the greater the reduction in hole mobility. In order to prevent significant reduction in the hole mobility, the “∅_{bh}” is less than “kT”.

The electron traps may be polymers or small molecule materials. The electron traps may be uniformly distributed throughout the emissive polymer layer, or may be concentrated in a particular region of the emissive polymer layer such as near the interface where electrons are injected into the emissive polymer layer (e.g., the interface where electrons are injected into the emissive polymer layer is the interface between the cathode and the emissive polymer layer).

FIG. 1 shows only one electron trap and one host component. However, in the case that traps are incorporated in the polymer chain, the resulting polymer chain would include at least one host component and at least one electron trap, preferably, at least one electron trap and many more host components. In the case of a mixture of polymers, the resulting mixture is comprised of at least one host polymer chain and at least one electron trap chain, preferably, at least one electron trap chain and many more host polymer chains, or one electron trap chain and a polymer host chain that is composed of multiple components and is a block or random copolymer.

The density of electron traps should be such that there is enough electron traps to reduce the electron mobility of the emissive polymer layer; however, the electron trap density should not be too high. At high densities, the electron traps are so close to each other such that trapped charges can be transported directly from one trap to another trap thus minimizing or eliminating the desired effect of reducing the electron mobility of the emissive polymer layer. The density of electron traps is less than ten mole percent of all the materials in the emissive polymer layer, preferably, the density of electron traps is less than one mole percent of all the materials in the emissive polymer layer.

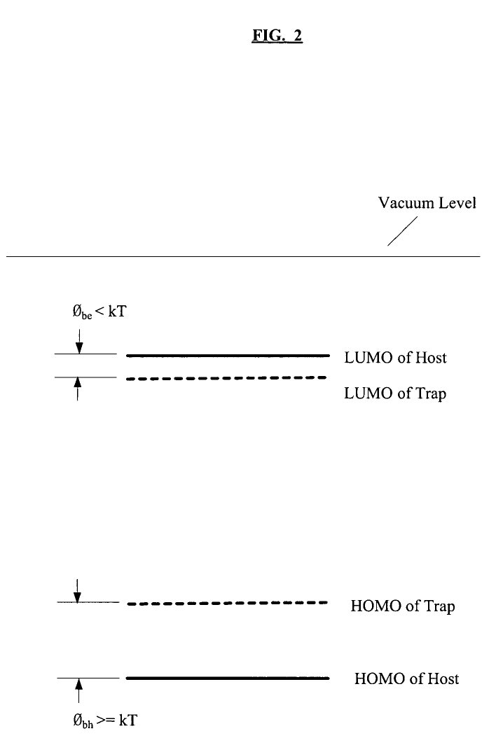

If the hole mobility of the emissive polymer layer is greater than the electron mobility, then traps can be added to the emissive polymer layer to trap holes in order to reduce the hole mobility so that it is closer to the electron mobility. FIG. 2 shows energy bands of a second configuration of an emissive polymer layer 113 in which a hole trap is added to a host component of the emissive polymer layer. The hole trap can be added to the host emissive polymer component by, for example, mixing these two components or by chemically bonding these two components. The two components can be chemically bonded by, for example, incorporating the hole trap within the main chain of the host component, or attaching the hole trap as a side group to the main chain of the host component. The hole trap has a HOMO level that is higher than the HOMO level of the host component. The reduction in hole mobility due to the trap depends in part on the height of the energy barrier to trap holes (i.e., “∅_{bh}”). The larger the barrier height, the greater the reduction in hole mobility. If “∅_{bh}” is less than “kT”, then the trapping effect is not significant enough to reduce the hole mobility. If, however, “∅_{bh}” is much greater than “kT”, then holes are trapped and the trapped holes have a very low probability of having enough energy to be re-excited. In order to sufficiently trap the holes so that hole mobility is reduced, the “∅_{bh}” should be at least “kT”.

The hole trap does not significantly reduce the electron mobility of the emissive polymer layer 113. In order to prevent significant reduction in the electron mobility, the “∅_{be}” is less than “kT”.

The hole traps may be polymers or small molecule materials. The hole traps may be uniformly distributed throughout the emissive polymer layer, or may be concentrated in a particular region of the emissive polymer layer such as near the interface where holes are injected into the emissive polymer layer (e.g., the interface where holes are injected into the emissive polymer layer may be the interface between the HTL and the emissive polymer layer).

FIG. 2 shows only one hole trap and one host component. However, in the case that the traps are incorporated in the polymer chain, the resulting polymer chain would include at least one host component and at least one hole trap, preferably, at least one hole trap and many more host components. In the case of a mixture of polymers, the resulting mixture is comprised of at least one host polymer chain and at least one hole trap chain, preferably, at least one hole trap chain and many more host polymer chains, or one hole trap chain and a polymer host chain that is composed of multiple components and is a block or random copolymer.

The density of hole traps should be such that there is enough hole traps to reduce the hole mobility of the emissive polymer layer; however, the hole trap density should not be too high. At high hole trap densities, the hole traps are so close to each other that trapped charges can be transported directly from one trap to another trap thus minimizing or eliminating the desired effect of reducing the hole mobility of the emissive polymer layer. The density of hole traps is less than ten mole percent of all the materials in the emissive polymer layer, preferably, the density of hole traps is less than one mole percent of all the materials in the emissive polymer layer.

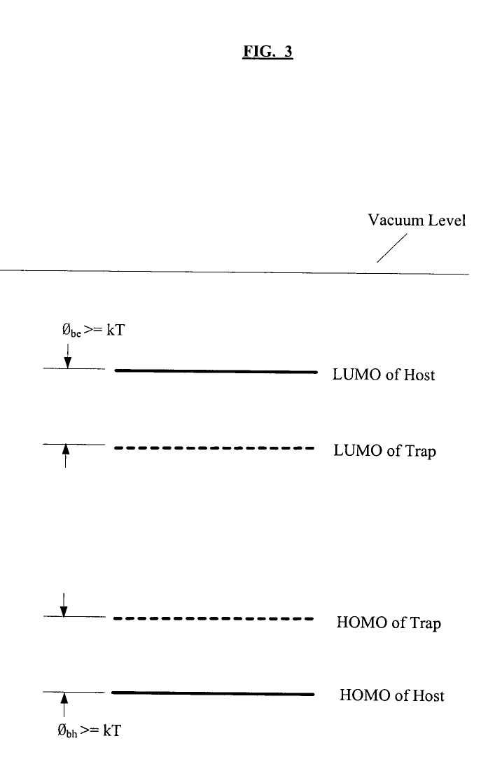

Electron/hole traps are used to trap both holes and electrons. Both holes and electrons can be trapped so that, for example, at least some of the emitted light is due to recombinations at the electron/hole traps. FIG. 3 shows energy bands of a third configuration of an emissive polymer layer 123 in which an electron/hole trap is added to a host component of the emissive polymer layer 123. The electron/hole trap can be added to the host emissive component by, for example, mixing these two components or by chemically bonding these two components. The two components can be chemically bonded by, for example, incorporating the electron/hole trap within the main chain of the host component, or attaching the electron/hole trap as a side group to the main chain of the host component. The electron/hole trap has a HOMO level that is higher than the HOMO level of the host component. In order to sufficiently trap the holes so that hole mobility is reduced, the “∅_{bh}” should be at least “kT”. The electron/hole trap has a LUMO level that is lower than the LUMO level of the host component. In order to sufficiently trap the electrons so that electron mobility is reduced, the “∅_{be}” should be at least “kT”. The barriers for trapping electrons “∅_{be}” and the barriers for trapping holes “∅_{bh}” do not have to be the same and preferably are chosen such that the resulting mobilities of the two carriers are made similar.

The electron/hole traps may be polymers or small molecule materials. The electron/hole traps may be uniformly distributed throughout the emissive polymer layer, or may be concentrated in a particular region of the emissive polymer layer such as near the interface where electrons are injected into the emissive polymer layer, or the interface where holes are injected into the emissive polymer layer, or in the region of the emissive polymer layer that would result in maximum efficiency.

FIG. 3 shows only one electron/hole trap and one host component. However, in the case that the traps are incorporated in the polymer chain, the resulting polymer chain would include at least one host component and at least one electron/hole trap, preferably, at least one electron/hole trap and many more host components. In the case of a mixture of polymers, the resulting mixture is comprised of at least one host polymer chain and at least one electron/hole trap chain, preferably, at least one electron/hole trap chain and many more host polymer chains, or one electron/hole trap chain and a polymer host chain that is composed of multiple components and is a block or random copolymer.

The density of electron/hole traps should be such that there is enough electron/hole traps to reduce the hole mobility and the electron mobility of the emissive polymer layer; however, the electron/hole trap density should not be too high. At high electron/hole trap densities, the electron/hole traps are so close to each other that trapped charges can be transported directly from one trap to another trap thus minimizing or eliminating the desired effect of reducing the hole and electron mobilities of the emissive polymer layer. The density of electron/hole traps is less than ten mole percent of all the materials in the emissive polymer layer, preferably, the density of electron/hole traps is less than one mole percent of all the materials in the emissive polymer layer.

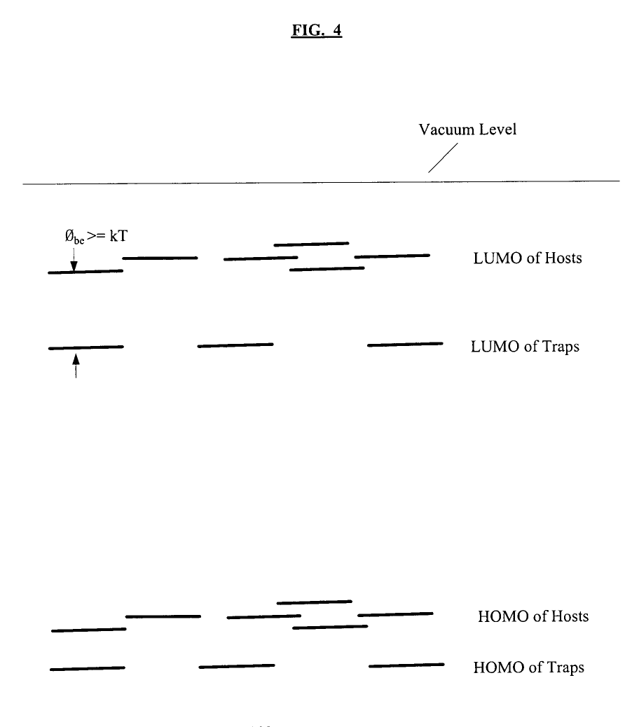

FIG. 4 shows an energy band diagram for the first configuration of the emissive polymer layer 103 in which electron traps are added to the host components. As described earlier, the electron traps have the energy barrier to trap electrons (i.e., “∅_{be}”) that is large enough to sufficiently trap the electrons so that the electron mobility of the emissive polymer layer is reduced. In order to sufficiently trap electrons so that the electron mobility is reduced, the “∅_{be}” should be at least “kT”. The electron traps should not significantly reduce the hole mobility of the emissive polymer layer. In order to prevent significant reduction in the hole mobility, the “∅_{bh}” is less than “kT”, or as shown in FIG. 4, the HOMO levels of the electron traps are lower than the HOMO levels of the host components.

When electron traps are added to the host components, since “∅_{bh}” is less than “kT” (thus, trapped holes will have enough energy to be re-excited into the HOMO level of the host) or the HOMO levels of the electron traps are lower than the HOMO levels of the host components (the holes prefer the lower energy of the host component sites), there is very small probability that both an electron and a hole will be present at the same electron trap at the same time and thus, the emission of visible light will be primarily due to recombinations at the host components. In this case, when electron traps are added to the host components of the emissive polymer layer, the emission spectrum is primarily controlled by the host components.

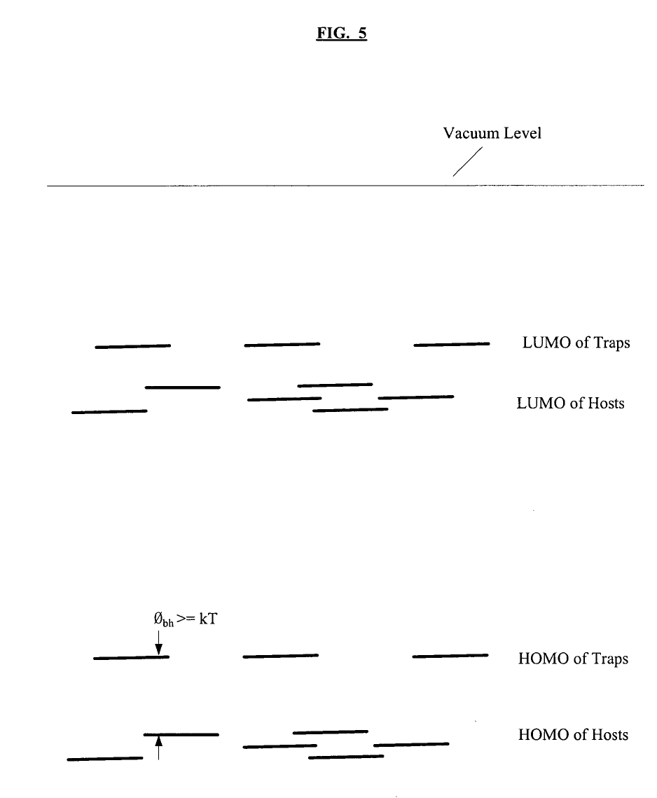

FIG. 5 shows an energy band diagram for the second configuration of the emissive polymer layer 113 in which hole traps are added to the host components. As described earlier, the hole traps have the energy barrier to trap holes (i.e., “∅_{bh}”) that is large enough to sufficiently trap the holes so that the hole mobility of the emissive polymer layer is reduced. In order to sufficiently trap holes so that the electron mobility is reduced, the “∅_{bh}” should be at least “kT”. The hole traps should not significantly reduce the electron mobility of the emissive polymer layer. In order to prevent significant reduction in the electron mobility, the “∅_{be}” is less than “kT”, or as shown in FIG. 5, the LUMO levels of the hole traps are higher than the LUMO levels of the host components.

When hole traps are added to the host components, since “∅_{be}” is less than “kT” or the LUMO levels of the hole traps are higher than the LUMO levels of the host components, there is very small probability that both an electron and a hole will be present at the same hole trap at the same time and thus, the emission of visible light will be primarily due to recombinations at the host components. In this case, when hole traps are added to the host components of the emissive polymer layer, the emission spectrum is primarily controlled by the host components.

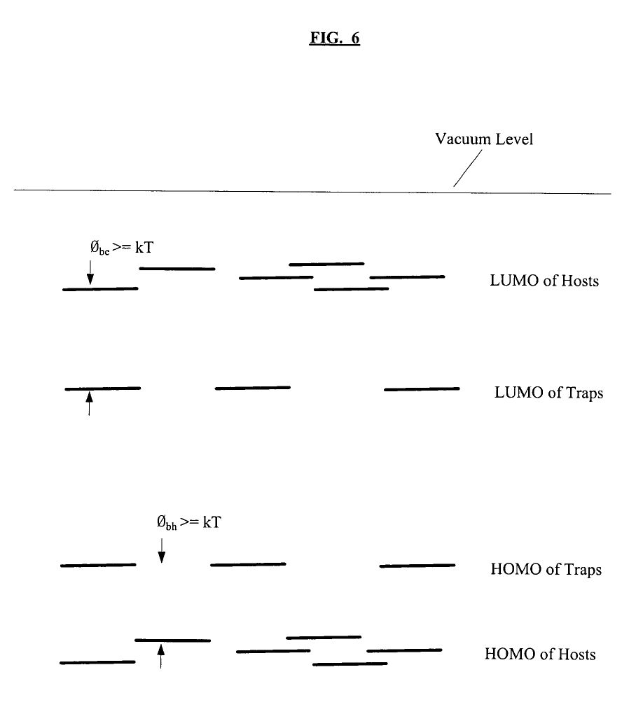

FIG. 6 shows an energy band diagram for the third configuration of the emissive polymer layer 123 in which electron/hole traps are added to the host components. Here, the electron/hole traps have a “∅_{be}” that is large enough to sufficiently trap the electrons so that the electron mobility of the emissive polymer layer is reduced. In order to sufficiently trap the electrons so that the electron mobility is reduced, the “∅_{be}” is at least “kT”. In addition, the electron/hole traps have the “∅_{bh}” that is large enough to sufficiently trap the holes so that the hole mobility of the emissive polymer layer is reduced. In order to sufficiently trap holes so that the hole mobility is reduced, the “∅_{bh}” is at least “kT”.

The “∅_{bh}” and “∅_{be}” of the electron/hole traps can be equal to each other or differ from each other. If they are approximately equal to each other, then the electron/hole traps reduce the hole mobility and the electron mobility of the emissive polymer layer by approximately the same amount. If, however, the “∅_{bh}” significantly differs from the “∅_{be}”, then the electron/hole traps affect the hole mobility of the emissive polymer layer differently than the electron mobility. For example, if “∅_{be}” is significantly greater than “∅_{bh}”, then the electron/hole traps reduce the electron mobility more than the hole mobility. Preferably, the “∅_{be}” and “∅_{bh}” are chosen such that the resulting mobilities of the electrons and holes are similar.

In this configuration in which each of the traps trap both holes and electrons, there is a high probability that both an electron and a hole will be present at the same electron/hole trap at the same time and thus, at least some of the visible light that is emitted is due to recombinations at the electron/hole traps. In this case, when electron/hole traps are added to the host components of the emissive polymer layer, the emission spectrum is controlled, in part, by the electron/hole traps. The number of recombinations at the electron/hole traps depend on the height of the barrier for the electrons to escape from the trap site (i.e., “∅_{be}”), the height of the barrier for the holes to escape from the trap site (i.e., “∅_{bh}”), and the density of the electron/hole traps. If there are a small number of electron/hole traps and large barrier heights, then recombinations occur at both the host components and the electron/hole traps. If there are a large number of electron/hole traps and large barrier heights, then recombinations occur primarily at the electron/hole traps. If there are a small number of electron/hole traps and small barrier heights, then recombinations occur primarily at the host components. If there are a large number of electron/hole traps and small barrier heights, then recombinations occur primarily at the host components. If a broad emission spectrum is desired (e.g., the OLED is to emit the color white), then the emissive polymer layer should include a small number of electron/hole traps and there should be large barrier heights. If the emissive polymer layer is to emit a single color, then it should include a large number of electron/hole traps and there should be large barrier heights if the emission is desired from the traps, or if the emission is desired from the host, then there should be either a large or small number of traps with small barrier heights.

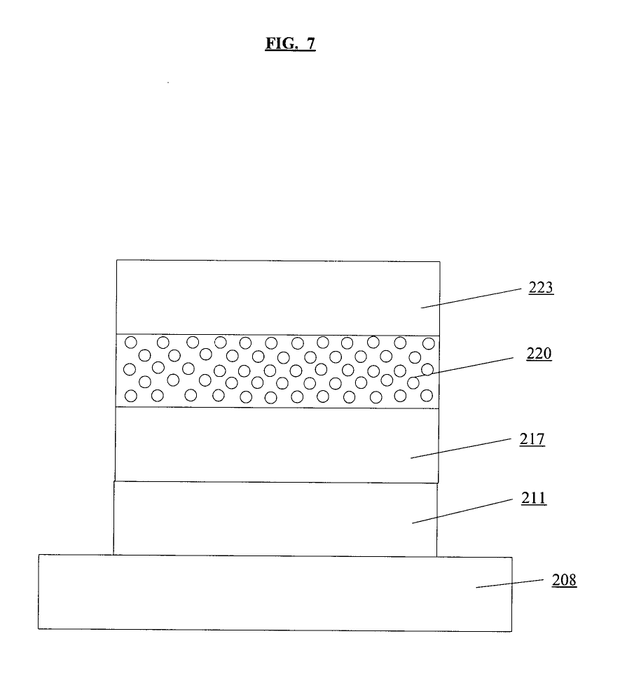

FIG. 7 shows a cross-sectional view of an embodiment of an electronic device 205 according to the present invention. The electronic device 205 can be any device that would benefit from adding traps to the emissive polymer layer in order to control the recombination zone to improve device efficiency and lifetime. Examples of electronic devices are an OLED pixel within an OLED display, and an OLED element within an OLED light source used for general purpose lighting. In FIG. 7, a anode 211 is on a substrate 208. As used within the specification and the claims, the term “on” includes when there is direct physical contact between the two parts and when there is indirect contact between the two parts because they are separated by one or more intervening parts. A HTL 217 is on the anode 211. An emissive polymer layer 220 is on the HTL 217. The cathode 223 is on the emissive polymer layer 220. These layers are described in greater detail below.

Substrate 208:

The substrate 208 can be any material, which can support the layers on it. The substrate 208 can be transparent or opaque (e.g., the opaque substrate is used in top-emitting devices). By modifying or filtering the wavelength of light which can pass through the substrate 208, the color of light emitted by the device can be changed. The substrate 208 can be comprised of glass, quartz, silicon, plastic, or stainless steel; preferably, the substrate 208 is comprised of thin, flexible glass. The preferred thickness of the substrate 208 depends on the material used and on the application of the device. The substrate 208 can be in the form of a sheet or continuous film. The continuous film is used, for example, for roll-to-roll manufacturing processes which are particularly suited for plastic, metal, or metallized plastic foils. The substrate 208 can also have transistors or other switching elements built in to control the operation of the device.

Anode 211:

The anode is a conductive layer which serves as a hole-injecting layer. The anode 211 is comprised of a high work function material; for example, the anode 211 can have a work function greater than about 4.5 eV. Typical anode materials include metals (such as platinum, gold, palladium, nickel, indium, and the like); metal oxides (such as tin oxide, indium tin oxide (“ITO”), and the like); graphite; doped inorganic semiconductors (such as silicon, germanium, gallium arsenide, and the like); or highly doped conducting polymers (such as polyaniline, polypyrrole, polythiophene, and the like).

The anode 211 can be transparent, semi-transparent, or opaque to the wavelength of light generated within the device. The thickness of the anode 211 is from about 10 nm to about 1000 nm, preferably, from about 50 nm to about 200 nm, and more preferably, is about 100 nm.

The anode 211 can typically be fabricated using any of the techniques known in the art for deposition of thin films, including, for example, vacuum evaporation, sputtering, electron beam deposition, or chemical vapor deposition.

HTL 217:

The HTL 217 has a much higher hole mobility than electron mobility and is used to effectively transport holes from the anode 211. The HTL 217 is comprised of polymers or small molecule materials. For example, the HTL 217 can be comprised of tertiary amine or carbazole derivatives both in their small molecule or their polymer form, conducting polyaniline (“PANI”), or polyethylenedioxythiophene-polystyrenesulfonate (“PEDOT:PSS”).

The HTL 217 functions as: (1) a buffer to provide a good bond to the substrate; and/or (2) a hole injection layer to promote hole injection; and/or (3) a hole transport layer to promote hole transport.

The HTL 217 can be deposited using selective deposition techniques or nonselective deposition techniques. Examples of selective deposition techniques include, for example, ink jet printing, flex printing, and screen printing. Examples of nonselective deposition techniques include, for example, spin coating, dip coating, web coating, and spray coating.

Emissive Polymer Layer 220:

The emissive polymer layer 220 is comprised of a light-emitting organic polymer material. Examples of organic polymer materials include polyphenylenevinylene (“PPV”) or derivatives thereof, and polyfluorene (“PF”) and derivatives thereof. The emissive polymer layer 220 includes at least one trap and at least one host component of the emissive polymer layer, preferably, the emissive polymer layer 220 includes multiple traps and even more host components. In FIG. 7, the traps are designated by the circles. The traps can be: (1) electron traps, (2) hole traps, and/or (3) electron/hole traps. The traps can be comprised of polymers or small molecule materials.

The traps may be uniformly distributed throughout the emissive polymer layer 220, or may be concentrated in a particular region of the emissive polymer layer such as near the interface where electrons are injected into the emissive polymer layer 220 (i.e., the interface between the cathode 223 and the emissive polymer layer 220), or the interface where holes are injected into the emissive polymer layer 220 (i.e., the interface between the HTL 217 and the emissive polymer layer 220).

The density of traps should be such that there is enough traps to reduce the mobility of one or both of the charges; however, the trap density should not be so high that the traps are too close to each other such that trapped charges can be transported directly from one trap to another trap thus minimizing or eliminating the desired effect of reducing the mobility of the charges. The density of the traps is less than ten mole percent of the emissive polymer layer, preferably, the density of the traps is less than one mole percent.

If electron traps or hole traps are added to the host components of the emissive polymer layer, then there is very small probability that both an electron and a hole will be present at the same trap at the same time and thus, the emission of visible light will be primarily due to recombinations at the host components. If, however, electron/hole traps are added to the host components of the emissive polymer layer, then there is a high probability that both an electron and a hole will be present at the same electron/hole trap at the same time and thus, at least some of the visible light that is emitted is due to recombinations at the electron/hole traps. Electron/hole traps and electron traps or hole traps can both be present in the same emissive polymer layer. For example, in the case where the electron mobility is greater than the hole mobility, the electron/hole traps can be added to the emissive polymer layer to reduce the electron mobility (e.g., the electron mobility is reduced more than the hole mobility if “∅_{be}” is greater than “∅_{bh}”) while affecting the color of the emitted light (when electron/hole traps are added, at least some of the emitted light will be due to recombinations at the electron/hole traps). In addition, electron traps can also be added to this emissive polymer layer to reduce the electron mobility and these traps do not substantially affect the color of the emitted light.

The thickness of the emissive polymer layer 220 is from about 5 nm to about 500 nm, and preferably, from about 20 nm to about 100 nm.

The emissive polymer layer 220 can be deposited using selective deposition techniques or nonselective deposition techniques. Examples of selective deposition techniques include, for example, ink jet printing, flex printing, and screen printing. Examples of nonselective deposition techniques include, for example, spin coating, dip coating, web coating, and spray coating.

Cathode 223:

The cathode 223 is a conductive layer which serves as an electron-injecting layer and which comprises a material with a low work function. While the cathode 223 can be comprised of many different materials, preferable materials include aluminum, silver, magnesium, calcium, barium, or combinations thereof. More preferably, the cathode 223 is comprised of aluminum, aluminum alloys, or combinations of magnesium and silver. There can also be an insulating layer between the cathode and the emissive polymer layer to enhance electron injection by tunneling. The insulating layer can be made of, for example, lithium fluoride (“LiF”), sodium fluoride (“NaF”), or cesium fluoride (“CsF”).

The cathode 223 can be opaque, transparent, or semi-transparent to the wavelength of light generated within the device. The thickness of the cathode 223 is from about 10 nm to about 1000 nm, preferably from about 50 nm to about 500 nm, and more preferably, from about 100 nm to about 300 nm.

The cathode 223 can typically be fabricated using any of the techniques known in the art for deposition of thin films, including, for example, vacuum evaporation, sputtering, electron beam deposition, or chemical vapor deposition.

While the OLED device has been described above in which an anode is deposited on the substrate, in an another configuration, the cathode is deposited on the substrate, the emissive polymer layer is deposited on the cathode, the HTL is deposited on the emissive polymer layer, and the anode is deposited on the HTL. This other configuration of the device may be employed in, for example, a top-emitting OLED display. The OLED devices described above can be used within displays in applications such as, for example, computer displays, information displays in vehicles, television monitors, telephones, printers, and illuminated signs.

As any person of ordinary skill in the art of OLED device fabrication will recognize from the description, figures, and examples that modifications and changes can be made to the embodiments of the invention without departing from the scope of the invention defined by the following claims.

1. An emissive polymer layer, comprising:
a plurality of host components; and
at least one of: (1) a plurality of electron traps, (2) a plurality of hole traps, and (3) a plurality of electron/hole traps,
wherein said plurality of electron traps reduce electron mobility within said emissive polymer layer, said plurality of hole traps reduce hole mobility within said emissive polymer layer, and said plurality of electron/hole traps reduce electron mobility and hole mobility within said emissive polymer layer.

2. The emissive polymer layer of claim 1 wherein an energy barrier to trap electrons between a LUMO level of said plurality of host components and a LUMO level of said plurality of electron traps is large enough to reduce electron mobility, and an energy barrier to trap holes between a HOMO level of said plurality of host components and a HOMO level of said plurality of electron traps is small enough so that hole mobility is not significantly reduced.

3. The emissive polymer layer of claim 2 wherein said energy barrier to trap electrons between said LUMO level of said plurality of host components and said LUMO level of said plurality of electron traps is at least a thermal energy, and said energy barrier to trap holes between said HOMO level of said plurality of host components and said HOMO level of said plurality of electron traps is less than said thermal energy.

4. The emissive polymer layer of claim 2 wherein visible light is emitted from said emissive polymer layer, said visible light primarily due to recombinations at said plurality of host components.

5. The emissive polymer layer of claim 1 wherein an energy barrier to trap holes between a HOMO level of said plurality of host components and a HOMO level of said plurality of hole traps is large enough to reduce hole mobility, and an energy barrier to trap electrons between a LUMO level of said plurality of host components and a LUMO level of said plurality of hole traps is small enough so that electron mobility is not significantly reduced.

6. The emissive polymer layer of claim 5 wherein said energy barrier to trap holes between said HOMO level of said plurality of host components and said HOMO level of said plurality of hole traps is at least a thermal energy, and said energy barrier to trap electrons between said LUMO level of said plurality of host components and said LUMO level of said plurality of hole traps is less than said thermal energy.

7. The emissive polymer layer of claim 5 wherein visible light is emitted from said layer, said visible light is primarily due to recombinations at said plurality of host components.

8. The emissive polymer layer of claim 1 wherein
an energy barrier to trap holes between a HOMO level of said plurality of host components and a HOMO level of said plurality of electron/hole traps is large enough to reduce hole mobility, and
an energy barrier to trap electrons between a LUMO level of said plurality of host components and a LUMO level of said plurality of electron/hole traps is large enough to reduce electron mobility.

9. The emissive polymer layer of claim 8 wherein
said energy barrier to trap holes between said HOMO level of said plurality of host components and said HOMO level of said plurality of electron/hole traps is at least a thermal energy, and
said energy barrier to trap electrons between said LUMO level of said plurality of host components and said LUMO level of said plurality of electron/hole traps is at least said thermal energy.

10. The emissive polymer layer of claim 9 wherein
said energy barrier to trap holes substantially differs from said energy barrier to trap electrons.

11. The emissive polymer layer of claim 9 wherein
said energy barrier to trap holes is approximately equal to said energy barrier to trap electrons.

12. The emissive polymer layer of claim 8 wherein visible light is emitted from said emissive polymer layer, wherein at least some of said visible light is due to recombinations at said plurality of electron/hole traps.

13. The emissive polymer layer of claim 1 wherein
a density of said plurality of electron traps is high enough to reduce electron mobility,
a density of said plurality of hole traps is high enough to reduce hole mobility, and
a density of said plurality of electron/hole traps is high enough to reduce electron mobility and hole mobility.

14. The emissive polymer layer of claim 13 wherein
said density of said plurality of electron traps is less than ten mole percent of said emissive polymer layer,
said density of said plurality of hole traps is less than ten mole percent of said emissive polymer layer, and
said density of said plurality of electron/hole traps is less than ten mole percent of said emissive polymer layer.

15. A method to form an emissive polymer layer, comprising:
adding a plurality of traps to a plurality of host components of said emissive polymer layer to reduce any one of: (1) hole mobility of said emissive polymer layer, (2) electron mobility of said emissive polymer layer, or (3) hole mobility of said emissive polymer layer and electron mobility of said emissive polymer layer.

16. The method of claim 15 wherein adding said plurality of traps includes
chemically bonding different portions of said plurality of traps to different portions of said plurality of host components, or
mixing a plurality of trap chains with a plurality of host polymer chains,
wherein each of said plurality of host polymer chains is a different portion of said plurality of host components and each of said plurality of trap chains is a different portion of said plurality of traps.

17. The method of claim 15 wherein said plurality of traps are any one of:
(1) a plurality of hole traps that reduce hole mobility of said emissive polymer layer,
(2) a plurality of electron traps that reduce electron mobility of said emissive polymer layer, or
(3) a plurality of electron/hole traps that reduce hole mobility of said emissive polymer layer and electron mobility of said emissive polymer layer.

18. The method of claim 17 wherein
said plurality of hole traps do not significantly reduce electron mobility of said emissive polymer layer, and
said plurality of electron traps do not significantly reduce hole mobility of said emissive polymer layer.

19. A method to increase at least one of: efficiency and lifetime of an OLED device, comprising:
trapping, within an emissive polymer layer, at least one of: (1) a portion of a plurality of electrons, and (2) a portion of a plurality of holes; and
reducing at least one of: (1) electron mobility of said emissive polymer layer by trapping said portion of electrons, and (2) hole mobility of said emissive polymer layer by trapping said portion of holes.

20. The method of claim 19 wherein
at least one of: (1) electron mobility of said emissive polymer layer and (2) hole mobility of said emissive polymer layer is reduced until a recombination zone is sufficiently far from a cathode so that quenching of emitted light is minimized and said recombination zone is sufficiently far from an interface between a hole transporting layer and said emissive polymer layer so that at least one of: device lifetime and efficiency is improved.

21. The method of claim 19 further comprising
insignificantly changing hole mobility of said emissive polymer layer if only said portion of electrons are trapped; and
insignificantly changing electron mobility of said emissive polymer layer if only said portion of holes are trapped.

22. The method of claim 19 further comprising
recombining at least most of said plurality of electrons and said plurality of holes at a plurality of host components of said emissive polymer layer if only said portion of electrons are trapped or only said portion of holes are trapped.

23. The method of claim 19 further comprising
recombining at least some of said plurality of electrons and said plurality of holes at a plurality of electron/hole traps if said plurality of electron/hole traps trap at least some of said portion of electrons and said portion of holes.

24. An organic light emitting diode (“OLED”) device, comprising:
a substrate;
an anode on said substrate;
a hole transporting layer on said anode;
an emissive polymer layer on said hole transporting layer; and
a cathode on said emissive polymer layer,
wherein said emissive polymer layer includes
a plurality of host components; and
at least one of: (1) a plurality of hole traps, (2) a plurality of electron traps, and (3) a plurality of electron/hole traps,
wherein said plurality of electron traps reduce electron mobility within said emissive polymer layer, said plurality of hole traps reduce hole mobility within said emissive polymer layer, and said plurality of electron/hole traps reduce electron mobility and hole mobility within said emissive polymer layer.

25. The OLED device of claim 24 wherein
at least one of: (1) said electron mobility of said emissive polymer layer and (2) said hole mobility of said emissive polymer layer is reduced until a recombination zone is sufficiently far from a cathode so that quenching of emitted light is minimized and said recombination zone is sufficiently far from an interface between said hole transporting layer and said emissive polymer layer so that at least one of: device lifetime and efficiency is improved.

26. The OLED device of claim 24 wherein said emissive polymer layer emits visible light wherein said visible light is primarily due to recombinations at said plurality of host components if said emissive polymer layer includes either a plurality of hole traps, or a plurality of electron traps.

27. The OLED device of claim 24 wherein said emissive polymer layer emits visible light, wherein some of said visible light is due to recombinations at said plurality of electron/hole traps if said emissive polymer layer includes electron/hole traps.

28. The OLED device of claim 24 wherein said device is any one of: an OLED pixel or an OLED light source element.
